(19) United States
(12) Patent Application Publication
(10) Pub. No.: US 2015/0235229 A1
(43) Pub. Date: Aug. 20, 2015

(54) CUSTOMER RELATIONSHIP DEVELOPMENT

(71) Applicant: OBSERVANT PTY LTD., Fitzroy (AU)

(72) Inventor: James Matthew Anderson Pryor, Melbourne (AU)

(21) Appl. No.: 14/432,984

(22) PCT Filed: Sep. 30, 2013
(86) PCT No.: PCT/AU2013/001120

§ 371 Date: Apr. 1, 2015

Related U.S. Application Data
(60) Provisional application No. 61/708,218, filed on Oct. 1, 2012.

(51) Int. Cl. G06Q 30/00; G06F 17/50

(52) U.S. Cl. CPC G06Q 30/01; G06F 17/5009

(57) ABSTRACT

Systems, methods and media are provided for customer relationship development. In an example embodiment, a computer-implemented method comprises causing display in a user interface, of one or more options in relation to a creation, by a user, of a virtual version of a physical system or service, and receiving specifications, in response to the displayed one or more options, from the user in relation the creation of the virtual system or service. In response to the received instructions, the virtual version of the physical system or service is created. In the virtual version of the physical system or service, a real-world operation of the physical system or service is simulated for the user.

### RELATED APPLICATIONS

This application claims priority from U.S. Provisional Patent Application Ser. No. 61/708,218, inventor James Matthew Anderson Pryor, entitled “Customer Relationship Development”, filed Oct. 1, 2012, which is incorporated herein by reference in its entirety and made a part hereof.

### BACKGROUND

For many companies that sell physical products it can be difficult to access modern business model approaches such as the “freemium” model in which a customer receives a certain portion of an offering for free but can upgrade to higher levels of functionality in return for higher payments.

Furthermore, it is an on-going problem in the world of marketing to create a sufficient incentive for prospective customers to provide information about their potential use of a new product or service. The problem is compounded for any offering that is dependent on further information that is user specific (such as information reliant on location and/or usage) to formulate an estimate of return on investment.

By way of example, if a service is designed to reduce travel between locations, but requires certain services to be available at those locations, the marketing organization must provide sufficient incentive for the prospective customer to disclose detailed information about the current situation, location and usage patterns in order to provide a compelling ROI argument. Prospective customers are often reluctant to divulge this information, or will only do so after direct questioning or if provided with a sufficient incentive.

The reference to any prior art in this specification is not, and should not be taken as, an acknowledgement or any form of suggestion that the prior art forms part of the common general knowledge.

### SUMMARY

In an example embodiment, a system comprises at least one module, executing on one or more computer processors, to cause display on a user interface, of one or more options in relation to a creation, by a user, of a virtual version of a physical system or service; receive specifications, in response to the displayed one or more options, from the user in relation the creation of the virtual system or service; in response to the received instructions, create the virtual version of the physical system or service; and simulate, for the user, in the virtual version of the physical system or service, a real-world operation of the physical system or service.

The at least one module may be further to source on-line sample data pertaining to or representative of a functionality of the physical system or service; and wherein the simulation of the real-world operation of the physical system or service includes a simulation of the real-world operation of the physical system or service based on the sourced sample data.

The one or more options displayed in the user interface may include an option of purchasing the physical system or service and may further include an option of selecting use, in the virtual version of the physical system or service, of real-world operational data in place of the sample data, the real-world operational data pertaining to or representative of a corresponding functionality of the physical system or service.

In some examples, the at least one module may be further to receive a request from the user to install or provide a purchased physical system or service. The at least one module may be further to monitor the installed or provided physical system or service; and include, in the virtual version of the physical system or service, selected real-world operational data.

In some examples, the at least one module may be further to transform the virtual version of the physical system or service into a real-world version of the system or service by progressively including the selected real-world operational data in place of the sample data.

The specifications received from the user may include user-related data, or other data relating to the physical system or service. The user-related data may be of any suitable type and may arise from any suitable source. In some embodiments, it comprises information entered by a user via a user-interface. In some embodiments the user-related data comprises location-based data which may optionally be captured by a function of the at least one module provided in a computing device such as a mobile computing device. In some embodiments, the user-related data is data associated with the user, for example the identity of the computing device, a history of usage of the device, a history of locations, or other information which may or may not be publicly available.

In some embodiments, once a user has purchased a real world system or service, the virtual data is replaced with real-world data associated with the purchased real-world system or service. The replacement may happen in any suitable way. For example, as real world data becomes available in relation to particular types of data, it can be used to replace equivalent virtual data of the same type. Equally though, the system may simply be refreshed to start showing real-world data when it becomes available.

In some preferred embodiments, the computing device is a portable one. In some embodiments, it is a handheld computing device, such as a smart phone.

Certain embodiments further comprise; calculating a projected return on investment in relation to an offered system or service and notifying the user of the results of the calculation. The return on investment calculation can be done in any suitable way. In some embodiments, the projected cost savings associated with use of the offered system or services are calculated. In one non-limiting example relating to monitoring equipment, the return on investment associated with reduced down-time of a monitored piece of equipment, or the reduced travel and maintenance expense associated with remotely monitoring an agricultural site, such as a watering point may be calculated.

Some embodiments further comprise the step of analysing usage of a system by a user. Such analysis may for example done on the virtual version of the physical system or service and be used to better understand a prospective or current customer's usage patterns and practices so as to provide a more tailored solution offering to them. In some instances, the real-world version is analysed. Such analysis may be used to suggest improvements to increase efficiency and/or decrease costs and/or to offer further goods and/or services. In some embodiments, use of the real-world version is compared with use of the virtual version, for example, in order to gain insights into the user's requirements.

Some embodiments comprise calculating and/or estimating at least partial costs associated with use of a real-life version. Such a calculation may be done in any suitable way. In some embodiments, the calculation is based on data inputted by the user and for example extrapolated. In some embodiments, the calculation is based on the way that a user uses a virtual version and applied to a real-world equivalent. Such calculations can be useful in a number of ways. For example, it may enable the system to suggest alterations in use in order to create savings, or increase efficiency. In some situations, such cost calculations may be used to customise a good and/or service offered to a user.

An important element of certain embodiments of the invention is that by providing a virtual version of the proposed good/and or service and allowing the user to interact with it, the system operator will gain important and insightful information about the proposed customer and their requirements. In some embodiments, it provides a reason or benefit to motivate the potential customer to provide important information that is needed to be able to offer a system or service, that is otherwise very hard to obtain. By offering the prospective customer the methods or systems according to the current invention, the prospective customer may be induced to reveal helpful information that a system designer or owner needs to know. In other applications, a prospective customer or existing user can capture costs of how an existing operation is performed, for example.

In some embodiments, a prospective customer can be presented with a return on investment proposal based on real world information to help with a sales pitch. Once a prospective customer has decided to purchase a physical system or service, the process of delivering and installing the system (and setting up the services) has already been greatly simplified. In some embodiments, the present subject matter allows a system operator to maintain an online, real-time relationship with the prospective customer right the way through to final installation and longer term operation.

The methods, media and systems of the invention are applicable in a wide-variety of situations. A few non-limiting examples would include offering remote monitoring equipment and services, electric vehicle sales (particular with a GPS enabled mobile computing device), maintenance and replacement of equipment (for example household appliances), for example with more energy efficient versions.

In another example embodiment, a machine readable medium, includes instructions, which when performed by a machine, causes the machine to perform the operations of causing display in a user interface, of one or more options in relation to a creation, by a user, of a virtual version of a physical system or service; receiving specifications, in response to the displayed one or more options, from the user in relation the creation of the virtual system or service; in response to the received instructions, creating the virtual version of the physical system or service; and simulating for the user, in the virtual version of the physical system or service, a real-world operation of the physical system or service.

Throughout this specification (including any claims which follow), unless the context requires otherwise, the word ‘comprise’, and variations such as ‘comprises’ and ‘comprising’, will be understood to imply the inclusion of a stated integer or step or group of integers or steps but not the exclusion of any other integer or step or group of integers or steps. Further, the term “system” is intended to include a “good”. In some examples and claims which follow these terms are used interchangeably.

### DESCRIPTION OF THE DRAWINGS

The example embodiments may be better understood, and its numerous features and advantages made apparent to those skilled in the art by referencing the accompanying drawings and descriptions provided in the Detailed Description. For ease of understanding and simplicity, common numbering of elements within the illustrations is employed where an element is the same in different drawings. In the drawings, which are not necessarily drawn to scale, like numerals may describe similar components in different views. In some instances, different numerals may describe similar components in different views. Like numerals having different letter suffixes may represent different instances of similar components. The drawings illustrate generally, by way of example, but not by way of limitation, various embodiments discussed in the present document.

FIG. 1 depicts a process flow of one embodiment of the invention relating to real-world monitoring hardware use

FIG. 2 depicts an example system implementation of the embodiment of FIG. 1.

FIG. 3 is a flow chart showing a method according to an example method embodiment.

FIG. 4 is a block diagram of a machine in the example form of a computer system within which a set of instructions may be executed for causing the machine to perform any one or more of the methodologies herein discussed

### DETAILED DESCRIPTION

The following is a detailed description of illustrative embodiments of the present invention. As these embodiments of the present invention are described with reference to the aforementioned drawings, various modifications or adaptations of the methods and or specific structures described may become apparent to those skilled in the art. All such modifications, adaptations, or variations that rely upon the teachings of the present inventions, and through which these teachings have advanced the art, are considered to be within the spirit and scope of the present invention. It is convenient to describe the invention herein in relation to particularly preferred embodiments. However, the invention is applicable to a wide range of situations and it is to be appreciated that other constructions and arrangements are also considered as falling within the scope of the invention. Various modifications, alterations, variations and or additions to the construction and arrangements described herein are also considered as falling within the ambit and scope of the present invention. Hence, these descriptions and drawings are not to be considered in a limiting sense, as it is understood that the present invention is in no way limited to the embodiments illustrated.

Some companies provide real-world services through an online interface. For example, companies that sell monitoring equipment can employ an online interface to coordinate and utilize information from the various pieces of monitoring equipment. In some companies, a major source of revenue is providing the online platform itself. However, in such circumstances, a major impediment to growth may be the requirement that customers purchase expensive capital equipment that can sense the real world environment in order to provide the base data that the services provide.

Often in such situations, once the capital equipment is installed, it in effect becomes invisible. The base data produced by the equipment might as well have originated online. Of course the decisions that are made based on the information relate to the physical world, but the task of acquiring the base data diminishes in importance.

Thus in some embodiments of the invention, by populating a system referenced to the real world, with virtual data, a prospective user can experience aspects of owning and operating a complete system without having to purchase or install any real-world equipment.

According to this aspect of the invention, a system is provided which offers far more than a mere demonstration. Instead, the user may for, example create a full system, sited at any location the user specifies, capturing one or more categories of data the user intends to monitor at that particular site. This custom specification can then be enacted on the system owner's servers, and be rendered or made in every respect to look, and feel the same as a complete system, except for the fact that all the data the user views is generated online based, for example, on samples of data similar to that intended to be generated or monitored by the user.

Such an embodiment allows a system owner to take a prospective user from a casual inquiry, to a “client capture” phase, through to the specification by the user/client of the desired sites, including the desired monitoring needs at each site. Once the system owner has this specification, the owner can quickly enact a fully virtualised system, and allow the user to log in and experience the system as if the equipment they specified had actually been installed and was operational. In some embodiments, such a virtual model can even react to commands from the user and change state, providing a simulation of control as well.

Once the user has been able to operate the desired system and is satisfied it will provide them with a valuable service, the system owner may have in some embodiments already captured all the information required to translate the user-specified specification into a complete order for all appropriate broader functionality and services.

The disclosed method of translating a casual inquiry into a virtual experience and then into a transaction for concrete (real-world) goods and services can work equally well in an online, mobile or bricks and mortar setting. Visitors to a web site or users of an application on a mobile device can move directly through this path. In other sales channels, for example, kiosks can be deployed in retail environments to enable prospective retail customers to enter certain particulars, specify the mapping location of the property they wish to monitor and each kind of equipment the Customer wishes to monitor. The specifications and details entered by the customer enable both the creation of a system having functionality which conforms exactly to specified needs, and the creation of a rich source of customer relationship data that can form the basis of future engagement with the prospective customer.

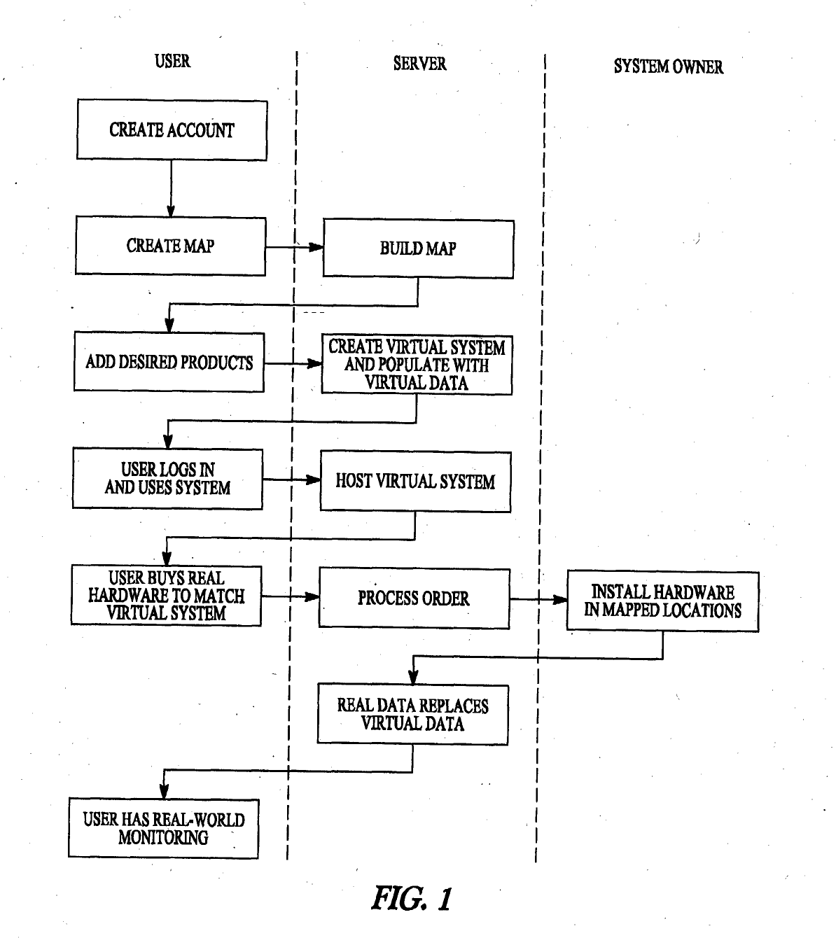

Turning now to FIG. 1, it can be seen that in some embodiments, a user first creates an account to use with the system and method of the invention. The user may be a potential customer. This account creation may comprise any suitable steps. In some preferred embodiments, information requested at this stage is kept to a minimum so as not to interfere with easy, simple sign-up by the user. In some embodiments, slightly more information may be requested, such as address and contact details, and so forth.

Once an account has been created, the user may use the user interface to create a map. This action causes a computing device such as a server to build the map. In addition, information inputted by the user in order to create the map is stored and associated with the user's account. In this way, relevant information is built up over time. The information can later be used to enable more tailored suggestions of systems and associated products and services.

Over time, the user as a potential customer may then add desired products or services to the map and in response the computing device can create a virtual version of the intended (real-world) system and thereafter populate it with virtual data. After this, the user may log back in to use the virtual system which may for example be hosted on the same server. Again, the user's interaction with the system will generate further data which can be captured and associated with the user's account for future customer service, customer relationship and marketing purposes.

After using the virtual system, a user may be presented with the option to purchase real-world hardware (system components) to match the virtual system. In some embodiments, further hardware is offered in addition to that chosen by the user for the virtual environment. This offering may be done in any suitable way, for example by “upsetting” improvements, or by suggesting functionality or hardware based on one or more items of information previously supplied by the user.

The user can then select the real-world hardware of interest, confirm the location and other relevant details at which the hardware should be installed, and pay for the order. The user may now be regarded as a captured client. In some embodiments, the system owner may then dispatch an installation team to install the ordered equipment on location as directed by the user. In other embodiments, the installation step may be outsourced to a third party or done by the customer.

Once the ordered hardware has been installed, the user's use of the system will switch from virtual to real data. This can be handled in any suitable way. For example, the user may simply click a “go live” button. In some embodiments, the virtual data may be maintained in parallel for a period of time for ready manipulation by the user (for example to enable sufficient data for comparison or other analytical functions until real world data has accumulated to a sufficient level).

In some embodiments of the system, the system monitors use by the user and makes suggestions as to hardware that may be useful, or satisfy one or more specific user needs. In some embodiments, the system can enable the user to add further virtual hardware as required for example to test a hypothesis, or for trial work and so forth, and thereafter be offered the opportunity to purchase real-world hardware in place of the virtual hardware.

In some embodiments the real-world hardware tracks its own maintenance and wear and tear and alerts the user via the user interface of the need to take one or more maintenance or, replacement actions. In such embodiments, the user may elect to add virtual data back in for a period of time while a piece of hardware is being repaired or waiting for replacement. Any suitable type of virtual data may be used. In some examples, it may comprise median, mean, or other statistically relevant data. This may be useful for example in situations in which a broader analytical assessment fails to function without at least some data present.

In some embodiments, the closest available public data is substituted for virtual data in this situation so as to better approximate real world conditions in the locality.

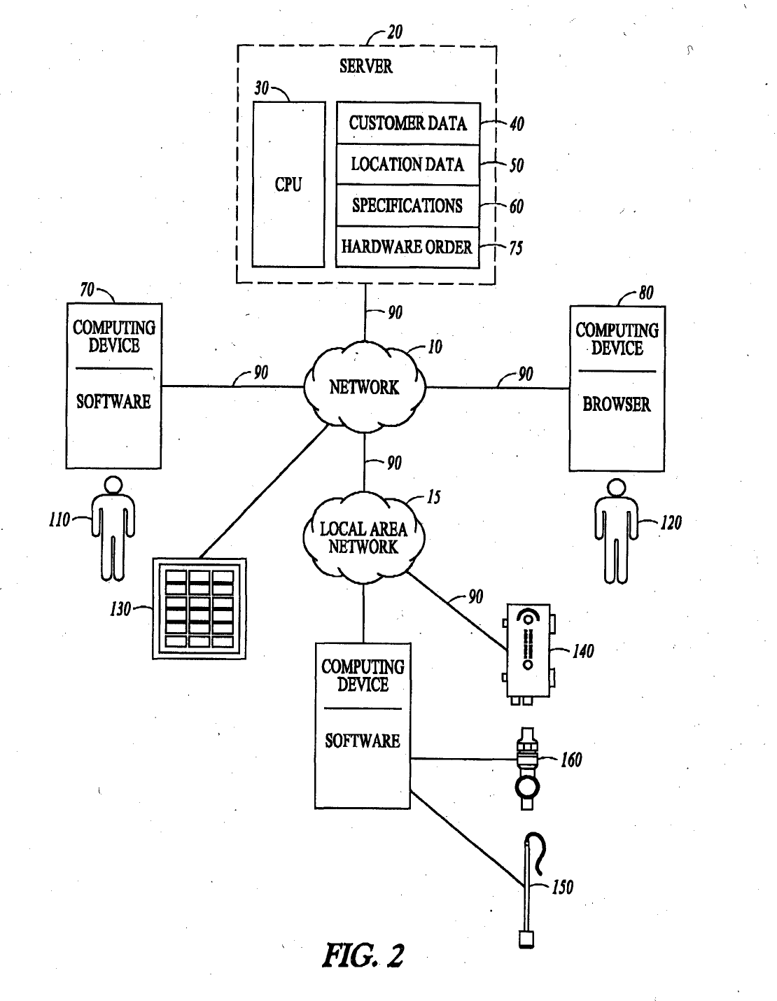

FIG. 2 depicts one example implementation of a system according to the invention. In this embodiment, a server 20 comprises a central processing unit CPU 30 and data stores (databases) for customer data 40, location data 50 and specifications 60. The server 20 is in communication via a communication link 90 to a network 10. Communication links 90 may be of any suitable form, including for example wireless, LAN, Bluetooth, or physical link and so forth.

For the purpose of this example, a user 110 has hardware comprising a telemetry system 130 and an engine controller 140 (for example controlling a petrol engine used to pump water). The controller 140 is in communication with local area network 15 which is in turn in communication with network 10. The telemetry system 130 is in direct communication with the network 10. The user 110 uses a computing device 70 to access the network 10 via another communications link, also labeled 90. The computing device 70 comprises local client software with a local user interface which can poll the server 20 via the network 10 to collect information and update a local database on the computing device 70. Computing device 70 may be any suitable device, for example a computer, a tablet, a smart phone, and so forth. In some embodiments, the software on the computing device 70 may comprise an ‘App’ for example for iOS or Android.

In this example, another user 120 owns hardware comprising a camera 160 and a water level sensor 150. Each of the camera 160 and sensor 150 can communicate directly with a local computing device which is in communication with the local area network 15 which in turn communicates with the network 10 and thereby with the server 20.

The user 120 uses a computing device 80 to access the system via network 10. The computing device 80 does not, in this example, have locally stored client software but instead uses a browser to access an interface on the server 20 via the network 10.

It will be appreciated that either the user 110 or the user 120 may have first used the illustrated system according to the invention in the manner described above in relation to FIG. 1. This prior use may thus include aspects such an initial communication with the server 20 in order to create an account, and then a selection of hardware to be placed at a location. In some examples, the server 20 stores customer data in data store 40 and location data in location data store 50. As either user 110 or user 120 adds further information about the virtual hardware being selected, this information can be taken from the specifications data store 60 and the resulting virtual set up can be added in customer data store 40.

After an appropriate time, the user 110 or the user 120 will in some examples be prompted by the server 20 to consider purchasing real-world versions of the virtual hardware selected. If either or both users decide to do so, then the CPU 30 will execute instructions to create appropriate prompts and create a hardware order to be processed and stored in a hardware order data store 75.

### Method Embodiments

Some embodiments of the present inventive subject matter include methods for customer relationship development.

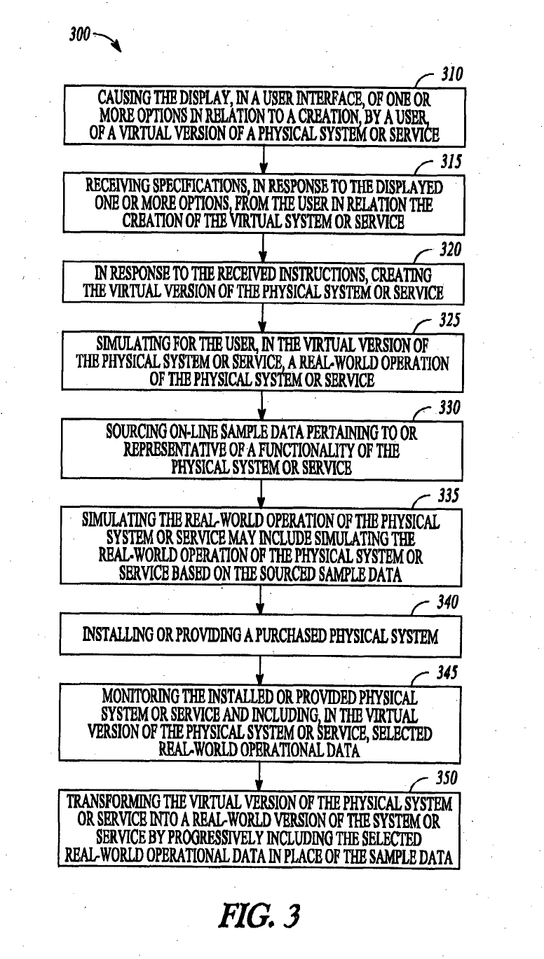

One such embodiment is illustrated in FIG. 3. In the example embodiment shown in FIG. 3, a method 300 comprises: at 305, causing display in a user interface: at 310, of one or more options in relation to a creation, by a user, of a virtual version of a physical system or service; at 315, receiving specifications, in response to the displayed one or more options, from the user in relation the creation of the virtual system or service; at 320, in response to the received instructions, creating the virtual version of the physical system or service; and at 325, simulating for the user, in the virtual version of the physical system or service, a real-world operation of the physical system or service.

The method 300 may further comprise, at block 330, sourcing on-line sample data pertaining to or representative of a functionality of the physical system or service; and at block 335, simulating the real-world operation of the physical system or service may include simulating the real-world operation of the physical system or service based on the sourced sample data.

In some examples, the one or more options displayed in the user interface includes an option of purchasing the physical system or service and further includes the option of selecting use, in the virtual version of the physical system or service, of real-world operational data in place of the sample data, the real-world operational data pertaining to or representative of a corresponding functionality of the physical system or service.

In some examples, the method 300 may further comprise, at block 340, installing or providing a purchased physical system. The method 300 may further comprise, at block 345, monitoring the installed or provided physical system or service; and including, in the virtual version of the physical system or service, selected real-world operational data.

In some examples, the method 300 further comprising, at block 350, transforming the virtual version of the physical system or service into a real-world version of the system or service by progressively including the selected real-world operational data in place of the sample data. The specifications received from the user include user-related data, or location-based data relating to the physical system or service.

These method embodiments are also referred to herein as “examples.” Such examples can include method elements in addition to those shown or described. However, the present inventors also contemplate examples in which only those method elements shown or described are provided. Moreover, the present inventors also contemplate examples using any combination or permutation of those method. elements shown or described above (or one or more aspects thereof), either with respect to a particular example (or one or more aspects thereof), or with respect to other examples (or one or more aspects thereof) shown or described herein.

### Processor Implementation

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The one or more processors may also operate to support performance of the relevant operations in a “cloud computing” environment or as a “software as a service” (SaaS). For example, at least some of the operations may. be performed by a group of computers (as examples of machines including processors), with these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures usually require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

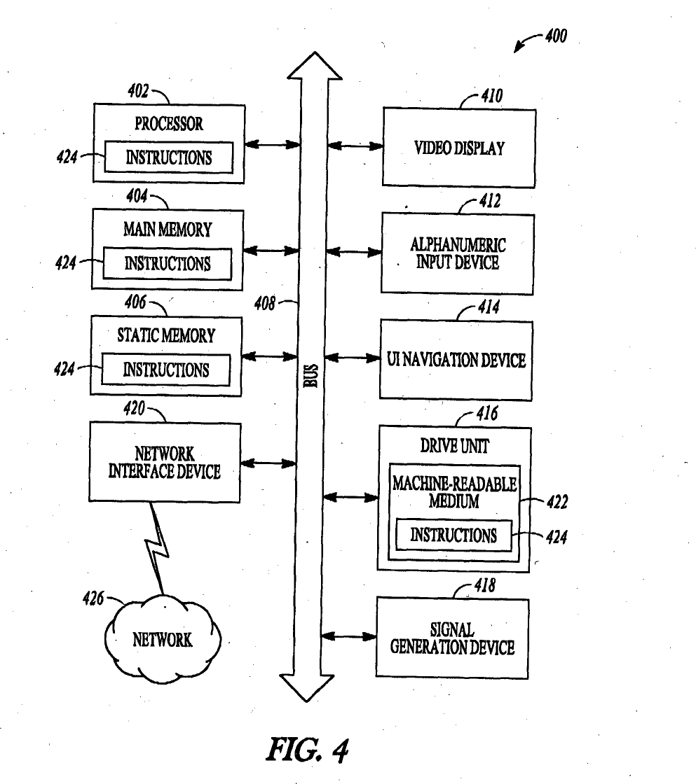

FIG. 4 is a block diagram of machine in the example form of a computer system 400 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a PDA, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU) or both), a main memory 404 and a static memory 406, which communicate with each other via a bus 408. The computer system 400 may further include a video display unit 410 (e.g., a liquid crystal display (LCD) or a cathode ray tube (CRT)). The computer system 500 also includes an alphanumeric input device 412 (e.g., a keyboard), a user interface (UI) navigation or cursor control device 414 (e.g., a mouse), a disk drive unit 416, a signal generation device 418 (e.g., a speaker) and a network interface device 420.

### Machine-Readable Medium

The disk drive unit 416 includes a machine-readable, medium 422 on which is stored one or more sets of data structures and instructions 424 (e.g., software) embodying or utilized by any one or more of the methodologies or functions described herein. The instructions 424 may also reside, completely or at least partially, within the main memory 404 and/or within the processor 402 during execution thereof by the computer system 500, with the main memory 404 and the processor 402 also constituting machine-readable media.

While the machine-readable medium 422 is shown in an example embodiment to be a single medium, the term “machine-readable medium” may include a single medium or multiple media (e.g., a centralized or distributed database, and/or associated caches and servers) that store the one or more data structures or instructions 424. The term “machine-readable medium” shall also be taken to include any tangible medium that is capable of storing, encoding, or carrying instructions for execution by the machine and that cause the machine to perform any one or more of the methodologies of the embodiments of the present invention, or that is capable of storing, encoding or carrying data structures utilized by or associated with such instructions. The term “machine-readable medium” shall accordingly be taken to include, but not be limited to, solid-state memories and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

### Transmission Medium

The instructions 424 may further be transmitted or received over a communications network 426 using a transmission medium. The instructions 424 may be transmitted using the network interface device 420 and any one of a number of well-known transfer protocols (e.g., HTTP). Examples of communication networks include a LAN, a WAN, the Internet, mobile telephone networks, Plain Old Telephone (POTS) networks, and wireless data networks (e.g., Wi-Fi™ and WiMax™ networks). The term “transmission medium” shall be taken to include any intangible medium that is capable of storing, encoding or carrying instructions for execution by the machine, and includes digital or analog communications signals or other intangible media to facilitate communication of such software.

### Statements

1. A computer-implemented method comprising: causing display in a user interface, of one or more options in relation to a creation, by a user, of a virtual version of a physical system or service; receiving specifications, in response to the displayed one or more options, from the user in relation the creation of the virtual system or service; in response to the received instructions, creating the virtual version of the physical system or service; and simulating for the user, in the virtual version of the physical system or service, a real-world operation of the physical system or service.

2. The method of statement 1, further comprising; sourcing on-line sample data pertaining to or representative of a functionality of the physical system or service; and wherein simulating the real-world operation of the physical system or service includes simulating the real-world operation of the physical system or service based on the sourced sample data.

3. The method of statement 2, wherein the one or more options displayed in the user interface includes an option of purchasing the physical system or service and further includes the option of selecting use, in the virtual version of the physical system or service, of real-world operational data in place of the sample data, the real-world operational data pertaining to or representative of a corresponding functionality of the physical system or service.

4. The method of statement 3, further comprising installing or providing a purchased physical system or service.

5. The method of statement 4, further comprising: monitoring the installed or provided physical system or service; and including, in the virtual version of the physical system or service, selected real-world operational data.

6. The method of statement 5, further comprising: transforming the virtual version of the physical system or service into a real-world version of the system or service by progressively including the selected real-world operational data in place of the sample data.

7. The method of statement 1, wherein the specifications received from the user include user-related data, or location-based data relating to the physical system or service.

8. A system comprising: at least one module, executing on one or more computer processors, to: provide a user interface; display in the user interface one or more options in relation to a creation, by a user, of a virtual version of a physical system or service; receive specifications, in response to the displayed one or more options, from the user in relation the creation of the virtual system or service; in response to the received instructions, create the virtual version of the physical system or service; and simulate for the user, in the virtual version of the physical system or service, a real-world operation of the physical system or service.

9. The system of statement 8, wherein the at least one module is further to: source on-line sample data pertaining to or representative of a functionality of the physical system or service; and wherein the simulation of the real-world operation of the physical system or service includes a simulation of the real-world operation of the physical system or service based on the sourced sample data.

10. The system of statement 9, wherein the one or more options displayed in the user interface includes an option of purchasing the physical system or service and further includes the option of selecting use, in the virtual version of the physical system or service, of real-world operational data in place of the sample data, the real-world operational data pertaining to or representative of a corresponding functionality of the physical system or service.

11. The system of statement 10, wherein the at least one module is further to receive a request from the user to install or provide a purchased physical system or service.

12. The system of statement 11, wherein the at least one module is further to: monitor the installed or provided physical system or service; and include, in the virtual version of the physical system or service, selected real-world operational data.

13. The system of statement 12, wherein the at least one module is further to: transform the virtual version of the physical system or service into a real-world version of the system or service by progressively including the selected real-world operational data in place of the sample data.

14. The system of statement 8, wherein the specifications received from the user include user-related data, or location-based data relating to the physical system or service.

15. A machine readable medium, including instructions, which when performed by a machine, causes the machine to perform the operations of: causing display in a user interface, of one or more options in relation to a creation, by a user, of a virtual version of a physical system or service; receiving specifications, in response to the displayed one or more options, from the user in relation the creation of the virtual system or service; in response to the received instructions, creating the virtual version of the physical system or service; and simulating for the user, in the virtual version of the physical system or service, a real-world operation of the physical system or service.

16. The medium of statement 15, wherein the operations further comprise: sourcing on-line sample data pertaining to or representative of a functionality of the physical system or service; and wherein simulating the real-world operation of the physical system or service includes simulating the real-world operation of the physical system or service based on the sourced sample data.

17. The medium of statement 16, wherein the one or more options displayed in the user interface includes an option of purchasing the physical system or service and further includes the option of selecting use, in the virtual version of the physical system or service, of real-world operational data in place of the sample data, the real-world operational data pertaining to or representative of a corresponding functionality of the physical system or service.

18. The medium of statement 17, wherein the operations further comprise installing or providing a purchased physical system or service.

19. The medium of statement 18, wherein the operations further comprise: monitoring the installed or provided physical system or service; and including, in the virtual version of the physical system or service, selected real-world operational data.

20. The medium of statement 19, wherein the operations further comprise: transforming the virtual version of the physical system or service into a real-world version of the system or service by progressively including the selected real-world operational data in place of the sample data.

21. The medium of statement 15, wherein the specifications received from the user include user-related data, or location-based data relating to the physical system or service.

### Non-Limiting Embodiments

While the invention has been described with reference to specific embodiments, it will be understood by those skilled in the art that various changes may be made and equivalents may be substituted for the elements thereof without departing from the true spirit and scope of the invention. In addition, modifications may be made without departing from the essential teachings of the invention. Moreover, each of the non-limiting examples described herein can stand on its own, or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A computer-implemented method comprising:
causing display in a user interface, of one or more options in relation to a creation, by a user, of a virtual version of a physical system or service;
receiving specifications, in response to the displayed one or more options, from the user in relation the creation of the virtual system or service;
in response to the received instructions, creating the virtual version of the physical system or service; and
simulating for the user, in the virtual version of the physical system or service, a real-world operation of the physical system or service.

2. The method of claim 1, further comprising;
sourcing on-line sample data pertaining to or representative of a functionality of the physical system or service; and wherein
simulating the real-world operation of the physical system or service includes simulating the real-world operation of the physical system or service based on the sourced sample data.

3. The method of claim 2, wherein the one or more options displayed in the user interface includes an option of purchasing the physical system or service and further includes the option of selecting use, in the virtual version of the physical system or service, of real-world operational data in place of the sample data, the real-world operational data pertaining to or representative of a corresponding functionality of the physical system or service.

4. The method of claim 3, further comprising installing or providing a purchased physical system or service.

5. The method of claim 4, further comprising:
monitoring the installed or provided physical system or service; and
including, in the virtual version of the physical system or service, selected real-world operational data.

6. The method of claim 5, further comprising:
transforming the virtual version of the physical system or service into a real-world version of the system or service by progressively including the selected real-world operational data in place of the sample data.

7. The method of claim 1, wherein the specifications received from the user include user-related data, or location-based data relating to the physical system or service.

8. A system comprising;
at least one module, executing on one or more computer processors, to:
display in a user interface, one or more options in relation to a creation, by a user, of a virtual version of a physical system or service;
receive specifications, in response to the displayed one or more options, from the user in relation the creation of the virtual system or service;
in response to the received instructions, create the virtual version of the physical system or service; and
simulate for the user, in the virtual version of the physical system or service, a real-world operation of the physical system or service.

9. The system of claim 8, wherein the at least one module is further to;
source on-line sample data pertaining to or representative of a functionality of the physical system or service; and wherein
the simulation of the real-world operation of the physical system or service includes a simulation of the real-world operation of the physical system or service based on the sourced sample data.

10. The system of claim 9, wherein the one or more options displayed in the user interface includes an option of purchasing the physical system or service and further includes the option of selecting use, in the virtual version of the physical system or service, of real-world operational data in place of the sample data, the real-world operational data pertaining to or representative of a corresponding functionality of the physical system or service.

11. The system of claim 10, wherein the at least one module is further to receive a request from the user to install or provide a purchased physical system or service.

12. The system of claim 11, wherein the at least one module is further to;
monitor the installed or provided physical system or service; and
include, in the virtual version of the physical system or service, selected real-world operational data.

13. The system of claim 12, wherein the at least one module is further to;
transform the virtual version of the physical system or service into a real-world version of the system or service by progressively including the selected real-world operational data in place of the sample data.

14. The system of claim 8, wherein the specifications received from the user include user-related data, or location-based data relating to the physical system or service.

15. A machine readable medium, including instructions, which when performed by a machine, causes the machine to perform operations comprising;
causing display in a user interface, of one or more options in relation to a creation, by a user, of a virtual version of a physical system or service;
receiving specifications, in response to the displayed one or more options, from the user in relation the creation of the virtual system or service;
in response to the received instructions, creating the virtual version of the physical system or service; and
simulating for the user, in the virtual version of the physical system or service, a real-world operation of the physical system or service.

16. The medium of claim 15, wherein the operations further comprise:
sourcing on-line sample data pertaining to or representative of a functionality of the physical system or service; and wherein
simulating the real-world operation of the physical system or service includes simulating the real-world operation of the physical system or service based on the sourced sample data.

17. The medium of claim 16, wherein the one or more options displayed in the user interface includes an option of purchasing the physical system or service and further includes the option of selecting use, in the virtual version of the physical system or service, of real-world operational data in place of the sample data, the real-world operational data pertaining to or representative of a corresponding functionality of the physical system or service.

18. The medium of claim 17, wherein the operations further comprise installing or providing a purchased physical system or service.

19. The medium of claim 18, wherein the operations further comprise:
monitoring the installed or provided physical system or service; and
including, in the virtual version of the physical system or service, selected real-world operational data.

20. The medium of claim 19, wherein the operations further comprise;
transforming the virtual version of the physical system or service into a real-world version of the system or service by progressively including the selected real-world operational data in place of the sample data.

21. The medium of claim 15, wherein the specifications received from the user include user-related data, or location-based data relating to the physical system or service.
